(19) United States
(12) Patent Application Publication
(10) Pub. No.: US 2015/0136663 A1
(43) Pub. Date: May 21, 2015

(54) METHOD AND SYSTEM FOR SEPARATING ALUMINUM AND MAGNESIUM FROM ASR ZORBA

(71) Applicant: Thomas Valerio, Atlanta, GA (US)

(72) Inventor: Thomas Valerio, Atlanta, GA (US)

(21) Appl. No.: 14/510,836

(22) Filed: Oct. 9, 2014

Related U.S. Application Data
(60) Provisional application No. 61/888,693, filed on Oct. 9, 2013.

(51) Int. Cl. B07B 9/02; B07B 4/08

(52) U.S. Cl. CPC B07B 9/02; B07B 4/08
USPC 209/44; 209/467

(57) ABSTRACT

Processing automobile shredder residue (ASR) zorba to separate aluminum and magnesium from the other non-ferrous metals. The system and method employs a destoner to separate the magnesium and aluminum from other non-ferrous metals in the ASR zorba. The resulting magnesium and aluminum product may be further processed by a destoner to separate the aluminum from the magnesium. The ASR zorba may be segregated by size prior to processing in the destoner.

### CROSS-REFERENCE TO RELATED APPLICATIONS

The present application claims priority under 35 U.S.C. Section 119(e) to U.S. Provisional Patent Application No. 61/888,693, filed Oct. 9, 2013, and titled “Method And System For Separating Aluminum And Magnesium From ASR Zorba,” the entire content of which is incorporated herein by reference.

### FIELD OF THE INVENTION

This invention relates to systems and methods for separating aluminum and magnesium from automobile shredder residue (ASR) zorba. More particularly, this invention relates to systems and methods for recovering aluminum and magnesium from zorba using a dry process.

### BACKGROUND OF THE INVENTION

Recycling of waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Typically, waste streams are composed of a variety of types of waste materials. One such waste stream is generated from the recovery and recycling of automobiles or other large machinery and appliances characterized by the fact that a majority of the material (typically over 65%) is made of ferrous metal. For examples, at the end of its useful life, an automobile is shredded. This shredded material is processed (by one or more large drum magnets) to recover most of the ferrous metal contained in the shredded material. The remaining materials, referred to as automobile shredder residue, or ASR, may still include ferrous and non-ferrous metals, including copper wire, aluminum, magnesium, and other recyclable materials. ASR is mainly made up of non-metallic material (dirt, dust, plastic, rubber, wood, foam, et cetera), non-ferrous metals (mainly aluminum but also brass, zinc, stainless steel, lead, magnesium, and copper) and some remaining ferrous metal that was not recovered by the first main ferrous recovery process (that is, the drum magnets).

The ASR resulting from the recovery of much of the ferrous metal in the waste stream is referred to as “virgin” ASR. Virgin ASR typically contains less than 15 percent metals. L. Fabrizi et al. provides a characterization of typical virgin ASR. ASR includes 23 percent elastomers; 13 percent glass and ceramics; 13 percent chlorine free thermosets and form parts; 13 percent iron; 7 percent foam material; 6 percent polyvinyl chloride (PVC); 6 percent other fibers and cover-materials; 5 percent other components; 4 percent wood, paper, and cardboard; 3 percent aluminum; 3 percent other thermosets; 3 percent paint; and 1 percent copper. See L. Fabrizi et al., Wire Separation from Automobile Shredder Residue, PHYSICAL SEPARATION IN SCIENCE AND ENGINEERING, Vol. 12, No. 3, pp. 145-165 (2003). Other studies show magnesium concentrations in virgin ASR to range from 0.05 to 0.8 weight percent.

Zorba definition is given by ISRI that is the Institute of Scrap Recycling Industries (www.isri.org) that provides definitions for many commodities in its Scrap Specifications Circular 2013 including Zorba that is defined as shredded nonferrous scrap that is predominantly aluminum. Typical metals include: aluminum, copper, lead, magnesium, stainless steel, nickel, tin, and zinc, in elemental or alloyed (solid) form. Zorba is better defined when followed by a number like Zorba 90 which means that material contains approximately 90% of non-ferrous metal content. Zorba is a result of typically, but not limited to, processing ASR through known processes: first through a ferrous separation with the purpose of reducing or eliminating iron and/or large iron attachments; after creating a mixed fraction of waste and non-ferrous metals with minimum iron content, the fraction can be separated in a non-ferrous metal separator, such as an eddy current. An eddy current separator separates the majority of the non-ferrous metals from other components. The result of this separation is zorba—a product of mixed non-ferrous metals.

Aluminum and magnesium are two specific components of the zorba produced from further processing virgin ASR to separate its components. Both aluminum and magnesium have commercial value—value that is increased if these metals are separated from the zorba. One such commercially valuable product is “twitch,” which is an aluminum product derived from wet or dry media separation of ASR, as defined by the Institute of Scrap Recycling Industries, Inc. To be classified as “twitch,” the material must be dry and not contain more than 1% maximum free zinc, 1% maximum free magnesium, and 1% maximum of analytical iron. Further, the material cannot contain more than a total 2% maximum of non-metallics, of which no more than 1% is to be rubber and plastics.

Aluminum and magnesium are relatively light weight as compared to other zorba components. For example, aluminum has a density of approximately 2,800 kilograms per cubic meter (kg/m³) and magnesium has a density of approximately 1,700 kg/m³. In comparison, tin has a density of approximately 7,300 kg/m³, stainless steel has a density of approximately 7,500 kg/m³, nickel has a density of approximately 8,900 kg/m³, copper has a density of approximately 9,000 kg/m³, and lead has a density of approximately 11,000 kg/m³. In the past, wet density separation processes have been used to separate the zorba components based on their relative densities. However, wet processes results in having to use and maintain costly separation media, which is typically a suspension of dense powders in water, such as ferrosilicon or magnetite. Further, the resulting separated components streams must be dried and, in some cases, cleaned of the separation media. These aspects of the process make further separation of zorba from ASR undesirable.

In view of the foregoing, a need exists for cost-effective, efficient methods and systems for separating aluminum and magnesium from zorba produced from the processing of ASR, including producing a twitch product.

### SUMMARY OF THE INVENTION

The present invention provides cost-effective, efficient methods and systems for separating aluminum and magnesium from zorba produced from the processing of ASR.

One aspect of the present invention provides a method for separating aluminum and magnesium from an automobile shredder residue zorba product. The method includes the steps of: receiving an ASR zorba product that includes aluminum, magnesium, and other non-ferrous metals; and processing the ASR zorba product into a destoner to generate a light fraction and a heavy fraction where the light fraction contains substantially all of the aluminum and the magnesium and the heavy fraction contains substantially all of the other non-ferrous metals.

Another aspect of the present invention provides a system for separating aluminum and magnesium from an automobile shredder residue zorba product. The system includes an ASR zorba product that includes aluminum, magnesium, and other non-ferrous metals; and a first destoner, operable to receive the ASR zorba product to generate a light fraction and a heavy fraction where the light fraction contains substantially all of the aluminum and the magnesium and the heavy fraction contains substantially all of the other non-ferrous metals.

### BRIEF DESCRIPTION OF THE DRAWINGS

FIG. 1 depicts a system diagram for separating aluminum and magnesium from ASR zorba in accordance with an exemplary embodiment of the present invention.

FIG. 2 depicts a process diagram for separating aluminum and magnesium from ASR zorba in accordance with an exemplary embodiment of the present invention.

### DETAILED DESCRIPTION OF THE EXEMPLARY EMBODIMENTS

Exemplary embodiments of the present invention provide systems and methods for separating aluminum and magnesium from zorba produced from the processing of ASR, including a twitch product.

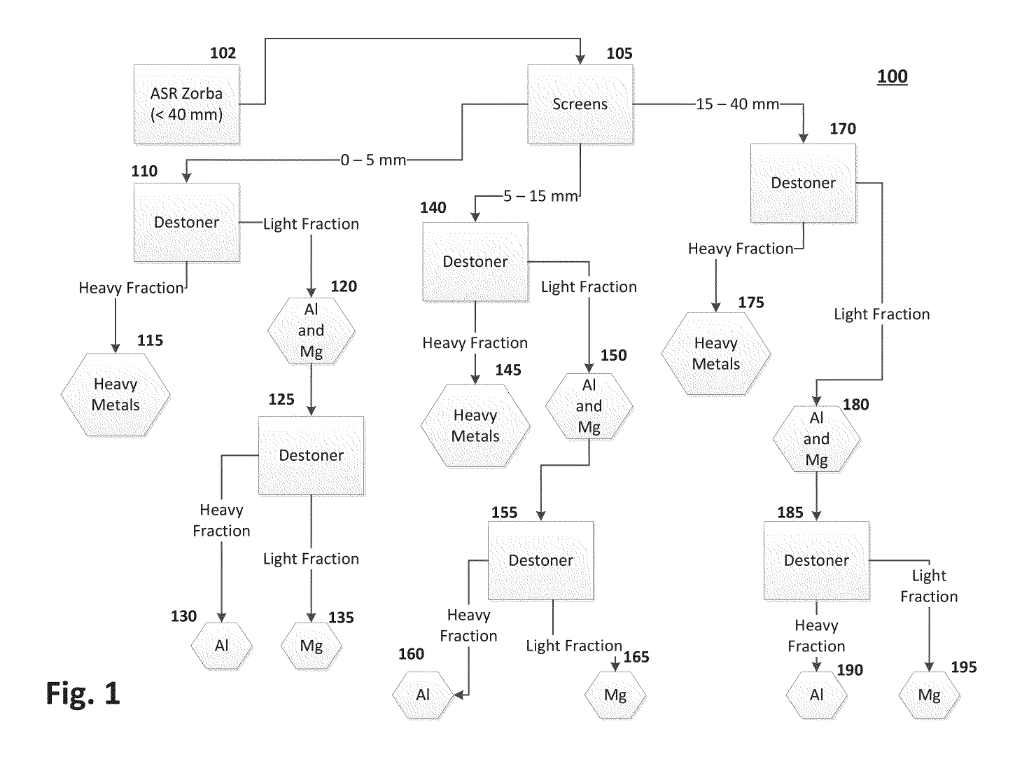

FIG. 1 depicts a system diagram for a system 100 for separating aluminum and magnesium from ASR zorba in accordance with an exemplary embodiment of the present invention. Referring to FIG. 1, an ASR zorba product 102 is received for further processing to separate out aluminum (Al) and magnesium (Mg) from the ASR zorba product 102. The ASR zorba product 102 is produced by processing ASR to separate the ASR zorba product 102 from the other components of ASR. Typically, constituent zorba materials of the ASR zorba product 102 will be less than 40 mm in size. This size is a result of the previous processing to separate the ASR zorba product 102 from the rest of the ASR components. In certain embodiments, the ASR zorba product 102 may be greater in size. In these embodiments where the constituent zorba materials are not less than 40 mm in size, the received ASR zorba product is processed as is or the ASR zorba product 102 is first processed by one or more size reducers (not shown) to reduce the zorba materials in size.

The ASR zorba product 102 is processed by one or more screens 105. The one or more screens 105 segregate the ASR zorba product 102 by size. In an exemplary embodiment, the one or more screens 105 segregate the ASR zorba product 102 into three size ranges: 0 to 5 millimeters (mm), 5 to 15 mm, and 15 to 40 mm. These size ranges are exemplary and a different number of ranges or different ranges can be used. In one exemplary embodiment, the one or more screens 105 may be omitted and a single size range matching the size range of the incoming ASR zorba product 102 may be further processed to separate the aluminum and magnesium as described below. These exemplary size ranges represent that the material that is capable of passing through a screen with a certain mesh size. For example, material in the 0-5 mm range passed through a screen with a mesh size of 5 mm. Material in the 5 mm-15 mm size range could not pass through a screen with a mesh size of 5 mm but did pass through a screen with a mesh size of 15 mm. Material in the 15 mm-40 mm size range could not pass through a screen with a mesh size of 15 mm but did pass through a screen with a mesh size of 40 mm. The constituents of the ASR zorba product 102 are not necessarily round and that one dimension could exceed the size range while another dimension does not. For example, an oblong particle could be 4 mm×7 mm and fall through a screen with a 5 mm mesh size.

The entire system 100 embodies a dry process. The ASR zorba received at the one or more screens 105 may be transported to the screens using a conveyor system, screw auger, or other known dry material conveyance system. Similar conveyance systems may be used with respect to other processing components of the system 100.

In the exemplary process 100, the ASR zorba product 102 in the size range of 0 to 5 mm is processed in a destoner 110. The destoner 110 is a type of gravity separation table used to separate granular material by density. A destoner includes a vibrating, screen-covered deck that is positioned on an incline, such that the deck slopes down in one direction. Granular material, such as the ASR zorba product 102, is introduced onto the deck as it vibrates. The screen allows air to flow up from beneath the deck. This air flow causes light components of the ASR zorba product 102 to float over the surface of the deck in a stratified mass. The heavier components remain close to or on the deck. The vibration and air flow actions cause the lighter strata to move down the inclined deck of the destoner 110 while the heavy strata move up the incline. In this way, a heavy fraction of the material can be collected at the upper end of the inclined deck while a light fraction can be collected at the lower end of the inclined deck. The heavy fraction includes heavier metal components of the ASR zorba product 102 while the light fraction includes lighter metal components of the ASR zorba product 102, containing primarily aluminum and magnesium.

To achieve the desired separation by the destoner 110, the air flow rate through the screen is adjusted until the heavy fraction and light fraction have the different constituents of interest. Other aspects of the destoner 110 are adjusted, both to fine tune the separation and to keep the separation operation stable throughout the process. For example, the frequency and amplitude of the vibrations of the deck can be adjusted. Also, the inclination of the deck can be adjusted (typically and indicatively from 5 degrees to 25 degrees). Additionally, the ASR zorba product 102 should be fed onto the destoner 110 deck in a consistent and constant manner to maintain the stability of the separation process.

The destoner 110 may be a pressure-type or vacuum-type design. A pressure-type destoner pushes air up through the screen of the deck, creating a positive pressure over the deck. This is accomplished such as by positioning a fan under the deck structure of the destoner. Typically, the pressure-type destoner has an open deck. A vacuum-type destoner creates a vacuum over the deck, creating a suction that pulls air through the screen of the deck. A vacuum-type destoner is enclosed with an air source downstream of the destoner deck.

Following processing in the destoner 110, two products are produced, a heavy metals product 115 (the heavy fraction from the destoner 110) and an aluminum and magnesium product 120 (the light fraction from the destoner 110). As indicated above, the aluminum and magnesium components of the ASR zorba product 102 have densities less than 3000 kg/m³, while the other components have density over 7000 kg/m³. The heavy metals product 115 may be recycled, further processed to remove other metal components, or disposed of. The aluminum and magnesium product 120 may be sold as is or further processed to separate the aluminum from the magnesium. In this latter embodiment, the aluminum and magnesium product 120 is introduced into a destoner 125. The destoner 125 may be the same piece of equipment as the destoner 110. In this configuration, the aluminum and magnesium product 120 would be recycled to the same destoner as used to generate the aluminum and magnesium product 120.

Preferably, the destoner 125 is a separate destoner from the destoner 110. In that way, the separation process can be run in a continuous manner, where the destoner 110 processes the 0 to 5 mm size range fraction of the ASR zorba product 102 continuously while the destoner 125 processes the resulting aluminum and magnesium product 120 continuously. The destoner 125 may be a pressure-type or vacuum-type design and may be a different type from the destoner 110, although employing the same type of destoners for the destoner 110 and the destoner 125 provides certain efficiencies in maintaining the process equipment. The air flow rate, deck vibration characteristics, and deck inclination are adjusted for destoner 125 to achieve the separation of the aluminum and magnesium. One or more of these parameters for the destoner 125 will likely differ from the parameters of the destoner 110, used to separate the ASR zorba product 102. As with the destoner 110, the air flow rate is adjusted until most of the aluminum is in the heavy fraction and most of the magnesium is in the light fraction. Deck vibration characteristics and deck inclination are adjusted to fine tune the separation and to achieve a stable separation process. Additionally, the aluminum and magnesium product 120 should be fed onto the destoner 125 deck in a consistent and constant manner to maintain the stability of the separation process.

Following processing in the destoner 125, two products are produced, an aluminum product 130 (the heavy fraction from the destoner 125) and a magnesium product 135 (the light fraction from the destoner 125). As indicated above, aluminum has a density of approximately 2,800 kilograms per cubic meter (kg/m³) and magnesium has a density of approximately 1,700 kg/m³, allowing for the two components to be separated into a heavy fraction and a light fraction in the destoner 125. The aluminum product 130 may be sold as a “twitch” product.

The 5 to 15 mm fraction of the ASR zorba product 102 is processed in a similar manner as the 0 to 5 mm fraction. The ASR zorba product 102 in the size range of 5 to 15 mm is processed in a destoner 140. The destoner 140 is a type of gravity separation table used to separate granular material by density. The destoner 140 may be a pressure-type or vacuum-type design. As with the destoner 110, the air flow rate is adjusted until the desired constituents are primarily in the light fraction (aluminum and magnesium) and the other constituents are primarily in the heavy fraction. Deck vibration characteristics and deck inclination are adjusted to fine tune the separation and to achieve a stable separation process. As previously discussed, the material should be fed to the destoner 140 deck in a consistent and constant manner to maintain the stability of the separation process.

Following processing in the destoner 140, two products are produced, a heavy metals product 145 (the heavy fraction from the destoner 140) and an aluminum and magnesium product 150 (the light fraction from the destoner 140). As indicated above, the aluminum and magnesium components of the ASR zorba product 102 have densities less than 3000 kg/m³, while the other components have density over 7000 kg/m³. The heavy metals product 145 may be recycled, further processed to remove other metal components, or disposed of. The aluminum and magnesium product 150 may be sold as is or further processed to separate the aluminum and magnesium components. In this latter embodiment, the aluminum and magnesium product 150 is introduced into a destoner 155. The destoner 155 may be the same piece of equipment as the destoner 140. In this configuration, the aluminum and magnesium product 150 would be recycled to the same destoner as used to generate the aluminum and magnesium product 150.

Preferably, the destoner 155 is a separate destoner from the destoner 140. In that way, the separation process can be run in a continuous manner, where the destoner 140 processes the 5 to 15 mm size range fraction of the ASR zorba product 102 continuously while the destoner 155 processes the resulting aluminum and magnesium product 150 continuously. The destoner 155 may be a pressure-type or vacuum-type design and may be a different type from the destoner 140, although employing the same type of destoners for the destoner 140 and the destoner 155 (and other destoners) provides certain efficiencies in maintaining the process equipment. As with the destoner 125, the air flow rate is adjusted until the magnesium is primarily in the light fraction by the destoner 155 and the aluminum is primarily in the heavy fraction produced by the destoner 155. Deck vibration characteristics and deck inclination are adjusted to fine tune the separation and to achieve a stable separation process. As previously discussed, the material should be fed to the destoner 155 deck in a consistent and constant manner to maintain the stability of the separation process.

In an alternative embodiment, the destoner 140 and destoner 155 are the same pieces of equipment as the destoner 110 and destoner 125. In this alternative configuration of system 100, the destoners operate in a continuous mode for a specific size range of the zorba product 102. The processing is then switched to process a different size range continuously. In this way, the system 100 would operate continuously for a certain size range of the ASR zorba product 102 and batch-wise for different size ranges of the ASR zorba product 102. If a single size range is used and the one or more screens 105 are omitted, then the destoners 110 and 125 would operate continuously on the single size range.

Following processing in the destoner 155, two products are produced, an aluminum product 160 (the heavy fraction from the destoner 155) and a magnesium product 165 (the light fraction from the destoner 155). As indicated above, aluminum has a density of approximately 2,800 kilograms per cubic meter (kg/m³) and magnesium has a density of approximately 1,700 kg/m³, allowing for the two components to be separated into a light fraction and heavy fraction in the destoner 155. The aluminum product 160 may be sold as a “twitch” product.

The 15 to 40 mm fraction of the ASR zorba product 102 is processed in a similar manner as the 0 to 5 mm fraction and 5 to 15 mm fraction. The ASR zorba product 102 in the size range of 15 to 40 mm is processed in a destoner 170. The destoner 170 is a type of gravity separation table used to separate granular material by density. The destoner 170 may be a pressure-type or vacuum-type design. As with the destoners 110, 140, the air flow rate of the destoner 170 is adjusted until the desired constituents are primarily in the light fraction (aluminum and magnesium) produced by the destoner 170 and the other constituents are primarily in the heavy fraction produced by the destoner 170. Deck vibration characteristics and deck inclination are adjusted to fine tune the separation and to achieve a stable separation process. As previously discussed, the material should be fed to the destoner 170 deck in a consistent and constant manner to maintain the stability of the separation process.

Following processing in the destoner 170, two products are produced, a heavy metals product 175 (the heavy fraction from the destoner 170) and an aluminum and magnesium product 180 (the light fraction from the destoner 170). As indicated above, the aluminum and magnesium components of the ASR zorba product 102 have densities less than 3000 kg/m³, while the other components have density over 7000 kg/m³. The heavy metals product 175 may be recycled, further processed to remove other metal components, or disposed of. The aluminum and magnesium product 180 may be sold as is or further processed to separate the aluminum and magnesium components. In this latter embodiment, the aluminum and magnesium product 180 is introduced into a destoner 185. The destoner 185 may be the same piece of equipment as the destoner 170. In this configuration, the aluminum and magnesium product 180 would be recycled to the same destoner as used to generate the aluminum and magnesium product 180.

Preferably, the destoner 185 is a separate destoner from the destoner 170. In that way, the separation process can be run in a continuous manner, where the destoner 170 processes the 15 to 40 mm size range fraction of the ASR zorba product 102 continuously while the destoner 185 processes the resulting aluminum and magnesium product 180 continuously. The destoner 185 may be a pressure-type or vacuum-type design and may be a different type from the destoner 170, although employing the same type of destoners for the destoner 170 and the destoner 185 (and other destoners) provides certain efficiencies in maintaining the process equipment. As with the destoners 125, 155, the air flow rate of the destoner 185 is adjusted until the magnesium is primarily in the light fraction produced by the destoner 185 and the aluminum is primarily in the heavy fraction produced by the destoner 185. Deck vibration characteristics and deck inclination are adjusted to fine tune the separation and to achieve a stable separation process. As previously discussed, the material should be fed to the destoner 185 deck in a consistent and constant manner to maintain the stability of the separation process.

In an alternative embodiment, the destoner 170 and destoner 185 are the same pieces of equipment as the destoner 110 and destoner 125. In this alternative configuration of system 100, the destoners operate in a continuous mode for a specific size range of the ASR zorba product 102. The processing is then switched to process a different size range continuously. In this way, the system 100 would operate continuously for a certain size range of the ASR zorba product 102 and batch-wise for different size ranges of the ASR zorba product 102.

Following processing in the destoner 185, two products are produced, an aluminum product 190 (the heavy fraction from the destoner 185) and a magnesium product 195 (the light fraction from the destoner 185). As indicated above, aluminum has a density of approximately 2,800 kilograms per cubic meter (kg/m³) and magnesium has a density of approximately 1,700 kg/m³, allowing for the two components to be separated into a light fraction and heavy fraction in the destoner 185. The aluminum product 190 may be sold as a “twitch” product.

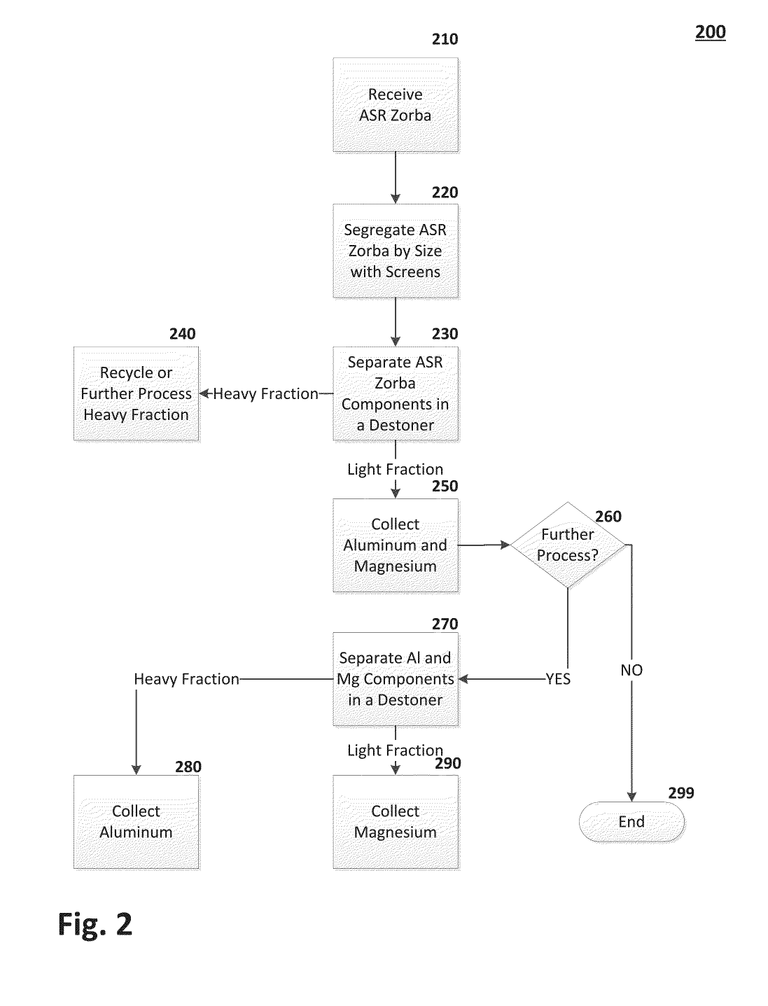

FIG. 2 depicts a process diagram for a process 200 for separating aluminum and magnesium from ASR zorba in accordance with an exemplary embodiment of the present invention. Referring to FIGS. 1 and 2, at step 210, ASR zorba, such as ASR zorba product 102, is received. Typically, the ASR zorba is 40 mm or less in size, but larger sizes of the ASR zorba may be processed. The ASR zorba results from processing ASR and separating out the zorba constituents from the remainder of the waste stream. For example, such technologies for separating ASR constituents are described in U.S. Pat. Nos. 7,674,994; 7,658,291; 7,732,726; 7,786,401; 8,056,730; 8,138,437; 8,158,902; 8,360,242; and 8,201,694. Such technologies are also described in U.S. patent application Ser. Nos. 12/917,159 (published as U.S. Patent Pub. 2011/0147501) and Ser. No. 13/616,948 (published as U.S. Patent Pub. 2013/0008832). The entire disclosures of these listed patents and patent applications are incorporated by reference herein.

At step 220, the ASR zorba is segregated by size, such as by the one or more screens 105. For example, the ASR zorba may be separated into three distinct material feedstreams to be processed—one with a size range of 0 to 5 mm, one with a size range of 5 to 15 mm, and one a size range of greater than 15 mm to the maximum size of the material, such as 40 mm. As discussed above, these exemplary size ranges represent that the material that is capable of passing through a screen with a certain mesh size. For example, material in the 0-5 mm range passed through a screen with a mesh size of 5 mm. Material in the 5 mm-15 mm size range could not pass through a screen with a mesh size of 5 mm but did pass through a screen with a mesh size of 15 mm. Material in the 15 mm-40 mm size range could not pass through a screen with a mesh size of 15 mm but did pass through a screen with a mesh size of 40 mm. These size ranges are exemplary and other size ranges may be used in alternative embodiments or step 220 may be omitted in an alternative embodiment.

At step 230, the sized ASR zorba is added to a destoner, such as destoners 110, 140, 170. At this step, process lines for different size ranges of ASR zorba are operated in parallel, such that, for example, one destoner operates on ASR zorba with a size range of 0 to 5 mm, another destoner operates on ASR zorba with a size range of 5 to 15 mm, and another destoner operates on ASR zorba with a size range of greater than 15 mm to the maximum size of the material, such as 40 mm. In an alternative embodiment, the different size ranges are operated batch-wise, where material in one size range is processed, then material in a second size range is processed, and so on.

Operating the destoners at step 230 results in two product stream—a heavy fraction and a light fraction. At step 240, the heavy fraction is collected. This fraction includes ASR zorba components that have densities greater than aluminum and magnesium, such as stainless steel, tin, lead, nickel, and copper. At step 240, this collected material is either recycled or further processed to separate constituents, such as copper, or disposed of.

At step 250, the light fraction is collected. The light fraction generated at step 250 contains most of the magnesium and aluminum from the ASR zorba, while containing a small fraction of the other metals in the zorba. As discussed above, the air flow rate and deck characteristics of the destoner are adjusted to achieve this separation. For example, a low air flow rate may cause only the lightest pieces of aluminum and magnesium, such as thin gauge pieces, to be in the light fraction. The air flow is increased until more than 95 percent of the aluminum and magnesium are in the light fraction and over 98 percent of the heavier metals are in the heavy fraction.

At step 260, the process 200 determines if the aluminum and magnesium is to be further processed. If the result of the inquiry at step 260 is “NO,” then the process 200 moves to step 299 and ends.

If the result of the inquiry at step 260 is “YES,” then the aluminum and magnesium product (the light fraction), such as aluminum and magnesium product 120, 150, 180, is introduced into a destoner, such as destoner 125, 155, 185, at step 270. This destoner may be the same destoner as used in step 230 or, preferably is a second destoner arranged in series relative to the destoner used at step 230. Again, at this step 270, process lines for different size ranges of ASR zorba are operated in parallel, such that, for example, one destoner operates on the aluminum and magnesium product with a size range of 0 to 5 mm, another destoner operates on the aluminum and magnesium product with a size range of 5 to 15 mm, and another destoner operates on the aluminum and magnesium product with a size range of greater than 15 mm to the maximum size of the material, such as 40 mm. In an alternative embodiment, the different size ranges are operated batch-wise, where material in one size range is processed, then material in a second size range is processed, and so on.

Operating the destoners at step 270 results in two product stream—a heavy fraction and a light fraction. At step 280, the heavy fraction is collected. The heavy fraction includes almost exclusively aluminum. At step 290, the light fraction is collected. The light fraction includes almost exclusively magnesium (e.g., over 90 percent). The aluminum product collected at step 280 will likely satisfy the definition of “twitch.” The airflow rate and other destoner parameters may be adjusted to ensure that the heavy fraction has no more than one percent of the magnesium to satisfy the requirements of “twitch.” In doing so, some aluminum may end up in the light fraction.

One of ordinary skill in the art would appreciate that the present invention provides systems and methods for separating aluminum and magnesium from zorba generated from the processing of ASR. The systems and methods employ air separators such as destoners to separate the metal components of the zorba based on the components density.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A method for separating aluminum and magnesium from an automobile shredder residue (ASR) zorba product comprising the steps of:
receiving an ASR zorba product comprising aluminum, magnesium, and other non-ferrous metals; and
processing the ASR zorba product by a destoner to generate a light fraction and a heavy fraction, wherein the light fraction contains substantially all of the aluminum and the magnesium and the heavy fraction contains substantially all of the other non-ferrous metals.

2. The method of claim 1, further comprising the step of segregating the ASR zorba product into a first feedstream and a second feedstream, wherein the first feedstream has a size range different from the second feedstream and wherein processing the ASR zorba product by the destoner comprises introducing the first feedstream, the second feedstream or both the first feedstream and the feedsecond stream into the destoner.

3. The method of claim 2, wherein the segregating step is accomplished using one or more screens.

4. The method of claim 2, wherein the destoner comprises a first destoner and a second destoner and wherein processing the ASR zorba product by the destoner comprises introducing the first feedstream into the first destoner and introducing the second feedstream into the second destoner.

5. The method of claim 1, wherein the ASR zorba product processed by the destoner consists of materials that are less than or equal to 40 mm in size.

6. The method of claim 1, further comprising the step of introducing the light fraction into the destoner to generate a second light fraction and a second heavy fraction wherein the second light fraction contains substantially all of the magnesium in the light fraction and wherein the second heavy fraction contains substantially all of the aluminum in the light fraction.

7. The method of claim 6, further comprising the step adjusting air flow of the destoner prior to introducing the light fraction into the destoner such that the destoner separates the magnesium in the light fraction from the aluminum in the light fraction.

8. A system for separating aluminum and magnesium from an automobile shredder residue (ASR) zorba product comprising:
a source of ASR zorba product, the ASR product comprising aluminum, magnesium, and other non-ferrous metals; and
a first destoner, operable to receive the ASR zorba product to generate a light fraction and a heavy fraction wherein the light fraction contains substantially all of the aluminum and the magnesium and the heavy fraction contains substantially all of the other non-ferrous metals.

9. The system of claim 8, further comprising a screen for segregating the ASR zorba product into a first feedstream and a second feedstream prior to introducing the ASR zorba product into the destoner, wherein the first feedstream has a size range different from the second feedstream.

10. The system of claim 9, wherein the first destoner comprises a second destoner for processing the first feedstream and a third destoner for processing the second feedstream.

11. The system of claim 8, wherein the screen comprises a mesh with a mesh size of less than or equal to 15 millimeters.

12. The system of claim 8, wherein the ASR zorba product processed by the destoner consists of materials that are less than or equal to 40 mm in size.

13. The system of claim 8, further comprising a second destoner operable to process the light fraction of the first destoner and to generate a second light fraction and a second heavy fraction such that the second light fraction contains substantially all of the magnesium and such that the second heavy fraction contains substantially all of the aluminum.
